(19) United States
(12) Patent Application Publication
(10) Pub. No.: US 2020/0252637 A1
(43) Pub. Date: Aug. 6, 2020

(54) MOVING IMAGE PROCESSOR, MOVING IMAGE PROCESSING SYSTEM, AND MOVING IMAGE PROCESSING METHOD

(71) Applicant: SOCIONEXT INC., Kanagawa (JP)

(72) Inventors: Yuya TAGAMI, Yokohama (JP); Yasuhiro WAKIMOTO, Yokohama (JP)

(21) Appl. No.: 16/853,248

(22) Filed: Apr. 20, 2020

Related U.S. Application Data
(63) Continuation of application No. PCT/JP2017/038582, filed on Oct. 25, 2017.

(51) Int. Cl. H04N 19/40; H04N 19/46

(52) U.S. Cl. CPC H04N 19/40; H04N 19/46

(57) ABSTRACT

A moving image processor includes an encoder configured to encode a moving image; an obtainer configured to obtain data used in a process of compressing the moving image to be encoded by the encoder; a detector configured to detect feature data representing a feature of the moving image from the moving image based on the data obtained by the obtainer; and an outputter configured to output the data encoded by the encoder and the feature data detected by the detector.

### CROSS-REFERENCE TO RELATED APPLICATIONS

This U.S. non-provisional application is a continuation application of, and claims the benefit of priority under 35 U.S.C. § 365(c) from PCT International Application PCT/JP2017/038582 filed on Oct. 25, 2017, designated the U.S., the entire contents of which are incorporated herein by reference.

### TECHNICAL FIELD

The present disclosure relates to a moving image processor, a moving image processing system, and a moving image processing method.

### BACKGROUND ART

Conventionally, techniques have been known that detect a person and the like from a moving image (video) captured by a camera such as a monitor camera, a TV broadcasting camera, and a smartphone. Such a detection process is performed by using software or dedicated hardware.

See, for example, Japanese Laid-Open Patent Applications No. 2009-140513, 2007-304857, 2012-181209, and 2017-068627; and WO 2015/129318.

Also, techniques have been known that detect a human face, behavior, and the like from a moving image captured by a camera.

However, in the conventional techniques, in the case of performing a process of detecting data related to a predetermined detection target from a moving image, there has been a problem that the process takes a relatively long time.

### SUMMARY

According to one embodiment, a moving image processor is provided that includes an encoder configured to encode a moving image; an obtainer configured to obtain data used in a process of compressing the moving image to be encoded by the encoder; a detector configured to detect feature data representing a feature of the moving image from the moving image based on the data obtained by the obtainer; and an outputter configured to output the data encoded by the encoder and the feature data detected by the detector.

### Advantage of the Invention

[symbol]

### BRIEF DESCRIPTION OF DRAWINGS

FIG. 1 is a diagram illustrating an example of a configuration of a communication system according to an embodiment.

FIG. 2 is a diagram illustrating an example of a hardware configuration of a moving image processor according to an embodiment;

FIG. 3 is a diagram illustrating an example of a hardware configuration of a terminal and a server according to an embodiment;

FIG. 4 is a diagram illustrating an example of a functional block diagram of a moving image processor according to an embodiment;

FIG. 5 is a diagram illustrating an example of a functional block diagram of a server according to an embodiment;

FIG. 6 is a flow chart illustrating an example of a process of detecting feature data performed by a moving image processor;

FIG. 7 is a diagram illustrating an example of a CTU;

FIG. 8A is a diagram illustrating motion vectors in HEVC;

FIG. 8B is a diagram illustrating motion vectors in HEVC;

FIG. 9 is a flow chart illustrating an example of a display process based on feature data on a server;

FIG. 10A is a diagram illustrating an example of a display process based on feature data on a server;

FIG. 10B is a diagram illustrating an example of a display process based on feature data on a server; and

FIG. 11 is a flow chart illustrating an example of processing performed by a moving image processor according to a second embodiment.

### EMBODIMENTS OF THE INVENTION

### First Embodiment

In the following, embodiments in the present disclosure will be described with reference to the drawings.

According to one aspect, it is possible to perform a process of detecting data related to a predetermined detection target from a moving image at relatively high speed.

<System Configuration>

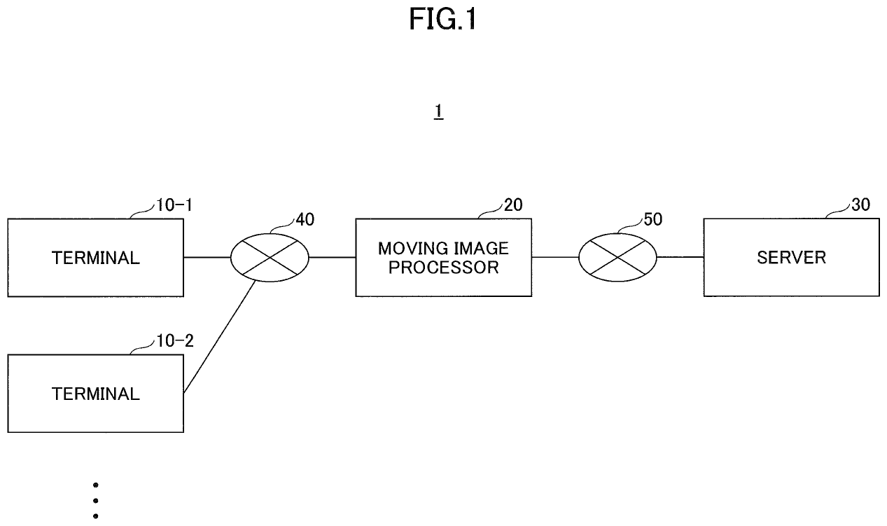

FIG. 1 is a diagram illustrating an example of a configuration of a communication system 1 (moving image processing system) according to the embodiment. In FIG. 1, the communication system 1 includes a terminal 10-1, 10-2, and so on (hereafter, simply referred to as “terminal(s) 10” if there is no need to distinguish one from another), a moving image processor 20, and a server 30. Note that the number of terminals 10 is not limited to two.

The terminals 10 and the moving image processor 20 are connected to a network 40, and the moving image processor 20 and server 30 are connected to a network 50, respectively, in states of being ready to communicate with each other, where each network may be, for example, the Internet, a cellular telephone network, a wireless LAN (Local Area Network), or a LAN.

The terminal 10 is, for example, an information processing apparatus (computer) such as a monitor camera, video camera, smartphone, or moving image (video) file server. The terminal 10 encodes a moving image captured by a camera and sound collected by a microphone according to a predetermined scheme (“first scheme”). Then, the terminal 10 distributes the encoded moving image and sound to the moving image processor 20 in real time through streaming distribution or the like. Alternatively, the terminal 10 accumulates the encoded moving image and sound as files, and uploads the files at a predetermined time to the moving image processor 20.

The moving image processor 20 is, for example, a transcoder that decodes a moving image captured and encoded by the terminal 10, and encodes the moving image by a predetermined scheme (“second scheme”). The moving image processor 20 decodes and encodes a moving image and sound received from the terminal 10, and distributes the encoded moving image and sound to the server 30 in real time through streaming distribution or the like. Alternatively, the moving image processor 20 accumulates the encoded moving image and sound as files, and uploads the files at predetermined times to the server 30. This enables to convert the moving image that has been received from the terminal 10 and encoded by various encoding schemes, by a predetermined encoding scheme to be accumulated on the server 30.

Also, when encoding a moving image, the moving image processor 20 detects feature data representing features of a moving image, adds the detected feature data to the moving image, and uploads the image to the server 30. The feature data may include data obtained by image processing or inference processing, such as the position of an object, the moving direction of the object, and the movement speed, and the brightness, color, sound change, sound volume, and the like.

The server 30 uses a moving image and feature data received from the moving image processor 20, to provide services, for example, monitoring of suspicious persons, management of visitors, marketing of stores and the like, distribution of a moving image, and analysis of a moving image, which may be performed using AI (Artificial Intelligence) or the like. The server 30 may distribute a moving image and sound received from the moving image processor 20 to an information processing terminal of the user in real time.

<Hardware Configuration>

<<Moving Image Processor>>

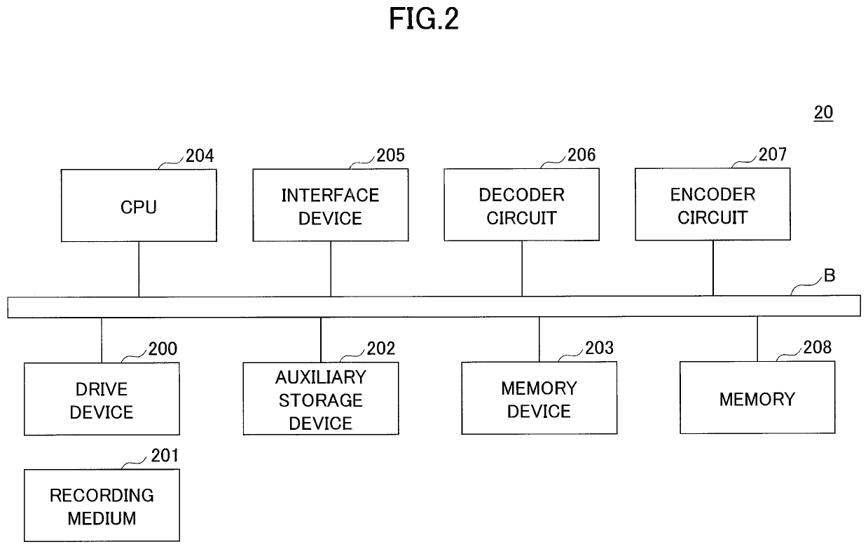

FIG. 2 is a diagram illustrating an example of a hardware configuration of the moving image processor 20 according to the embodiment. The moving image processor 20 in FIG. 2 includes a drive device 200, an auxiliary storage device 202, a memory device 203, a CPU (Central Processing Unit) 204, an interface device 205, a decoder circuit 206, an encoder circuit 207, and a memory 208, which are interconnected by a bus B.

A moving image processing program that implements the processing on the moving image processor 20 is provided by a recording medium 201. When the recording medium 201 storing the moving image processing program is set in the drive device 200, the moving image processing program is installed from the recording medium 201 into the auxiliary storage device 202 via the drive device 200. However, it is not always necessary to install the moving image processing program from the recording medium 201; the moving image processing program may be downloaded from another computer via the network. The auxiliary storage device 202 stores the installed moving image processing programs, and stores necessary files, data, and the like.

The memory device 203 reads out the program from the auxiliary storage device 202 and stores the program in itself upon receiving a command to activate the program. The CPU 204 implements functions related to the moving image processor 20 according to the program stored in the memory device 203. The interface device 205 is used as an interface for connecting to a network.

The decoder circuit 206 and the encoder circuit 207 are, for example, LSI (Large Scale Integration) circuits and the like, which are dedicated circuits to decode and encode a moving image, respectively. When encoding a moving image, upon completion of generation of predetermined data used for encoding, the encoder circuit 207 transfers the data from the internal memory of the encoder circuit 207 to the memory 208 by a scheme such as DMA (Direct Memory Access) to store the data. The CPU 204 uses the data stored in the memory 208, to generate feature data as will be described later.

Note that as an example of the recording medium 201, a portable recording medium such as a CD-ROM, DVD disk, USB memory, or the like may be considered. Also, as an example of the auxiliary storage device 202, an HDD (Hard Disk Drive), flash memory, or the like may be considered. Each of the recording medium 201 and the auxiliary storage device 202 corresponds to a computer-readable recording medium. The memory 208 may use part of the memory device 203.

<<Terminal and Server>>

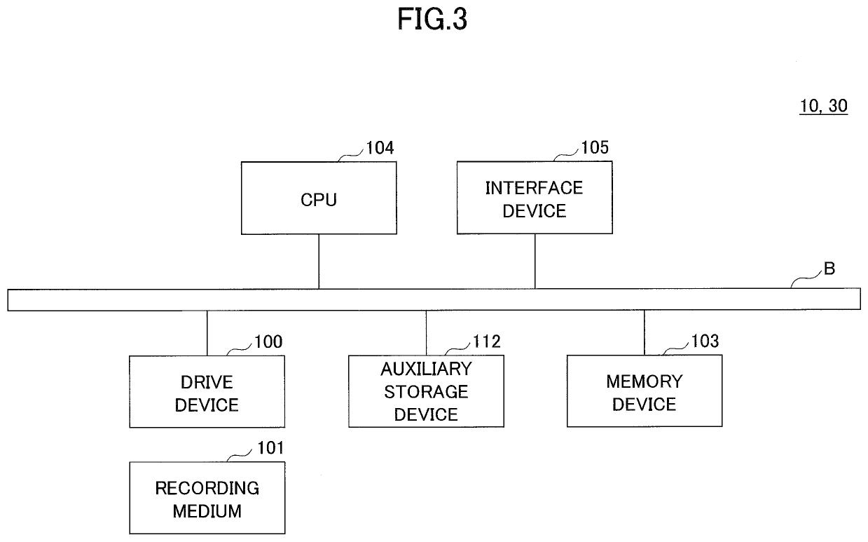

FIG. 3 is a diagram illustrating an example of a hardware configuration of the terminal 10 and the server 30 according to the embodiment. In the following, the configuration will be described with taking the server 30 as an example. The server 30 in FIG. 3 includes a drive device 100, an auxiliary storage device 102, a memory device 103, a CPU 104, and an interface device 105, which are connected with each other through a bus B.

A moving image processing program for implementing a process on the server 30 is provided with a recording medium 101. When the recording medium 101 storing the moving image processing program is set in the drive device 100, the moving image processing program is installed from the recording medium 101 into the auxiliary storage device 102 via the drive device 100. However, it is not always necessary to install the moving image processing program from the recording medium 101; the moving image processing program may be downloaded from another computer via the network. The auxiliary storage device 102 stores the installed moving image processing programs, and stores necessary files, data, and the like.

The memory device 103 reads out the program from the auxiliary storage device 102 and stores the program in itself upon receiving a command to activate the program. The CPU 104 implements functions relating to the server 30 according to the program stored in the memory device 103. The interface device 105 is used as an interface for connecting to a network.

Note that as an example of the recording medium 101, a portable recording medium such as a CD-ROM, DVD disk, USB memory, or the like may be considered. Also, as an example of the auxiliary storage device 102, an HDD (Hard Disk Drive), flash memory, or the like may be considered. Each of the recording medium 101 and the auxiliary storage device 102 corresponds to a computer-readable recording medium.

The hardware configuration of the terminal 10 may be similar to that of the server 30. Note that the terminal 10 has a camera (imaging device) for capturing a moving image in addition to the hardware elements illustrated in FIG. 3.

<Configuration>

<<Moving Image Processor>>

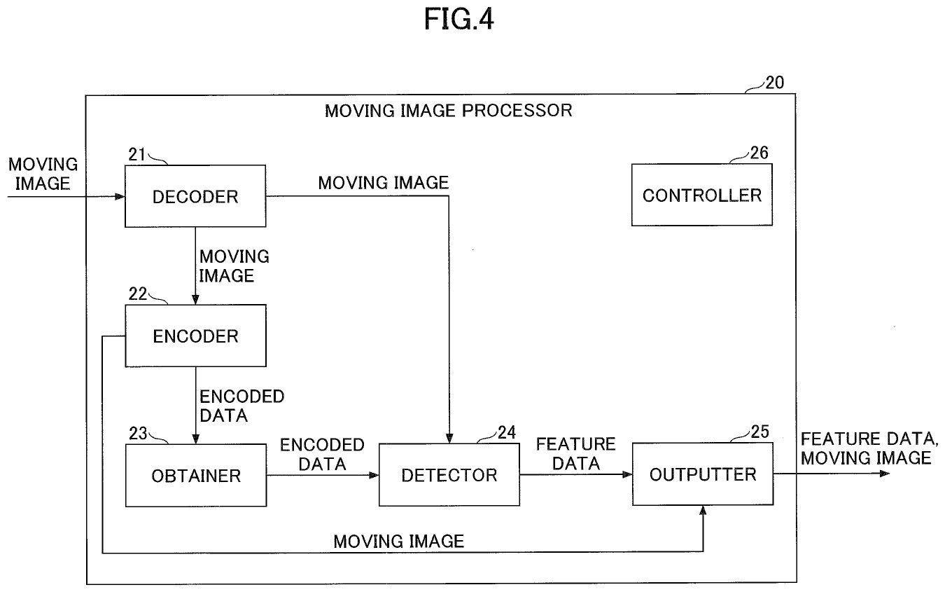

Next, with reference to FIG. 4, a configuration of the moving image processor 20 will be described. FIG. 4 is a diagram illustrating an example of a moving image processor 20 according to the embodiment. The moving image processor 20 includes a decoder 21, an encoder 22, an obtainer 23, a detector 24, an outputter 25, and a controller 26.

The decoder 21 is implemented by processes which the decoder circuit 206 illustrated in FIG. 2 or one or more programs installed in the moving image processor 20 cause the CPU 204 of the moving image processor 20 to execute. Note that in the case of implementing the decoder 21 by the CPU 204, it may be configured without the decoder circuit 206 illustrated in FIG. 2. In this case, the CPU 204 may be a multicore processor and a decoding process performed by the decoder 21 and a process of detecting feature data (metadata) by the detector 24 may be processed in parallel using different cores.

Also, in the case where the moving image processor 20 receives a moving image as unencoded raw data from the terminal 10 via a video cable or the like, the decoder 21 may not need to be included.

The encoder 22 is implemented using the encoder circuit 207 illustrated in FIG. 2. The obtainer 23 is implemented using the memory 208 illustrated in FIG. 2.

The detector 24, the outputter 25, and the controller 26 are implemented by processes which one or more programs installed in the moving image processor 20 cause the CPU 204 of the moving image processor 20 to execute. Note that a circuit that implements the detector 24, the outputter 25, and the controller 26 may be provided.

The decoder 21 decodes a moving image received from the terminal 10.

The encoder 22 compresses and encodes the moving image decoded by the decoder 21 by using compression standards for a moving image such as HEVC (High Efficiency Video Coding)/H.265 (hereafter, referred to as “HEVC”), AVC (Advanced Video Coding)/H.264, or the like.

The obtainer 23 obtains data that is used by the encoder 22 to compress and encode the moving image.

The detector 24 detects feature data representing features of the moving image received from terminal 10 from the moving image based on the data obtained by the obtainer 23.

The outputter 25 transmits to the server 30 data in which the moving image has been encoded by the encoder 22 and the feature data detected by the detector 24. Transmission of the data in which the moving image has been encoded and the feature data from the outputter 25 to the server 30 may be transmitted for each frame of the moving image, or multiple frames may be transmitted collectively.

The controller 26 performs overall control of the moving image processor 20.

<<Server>>

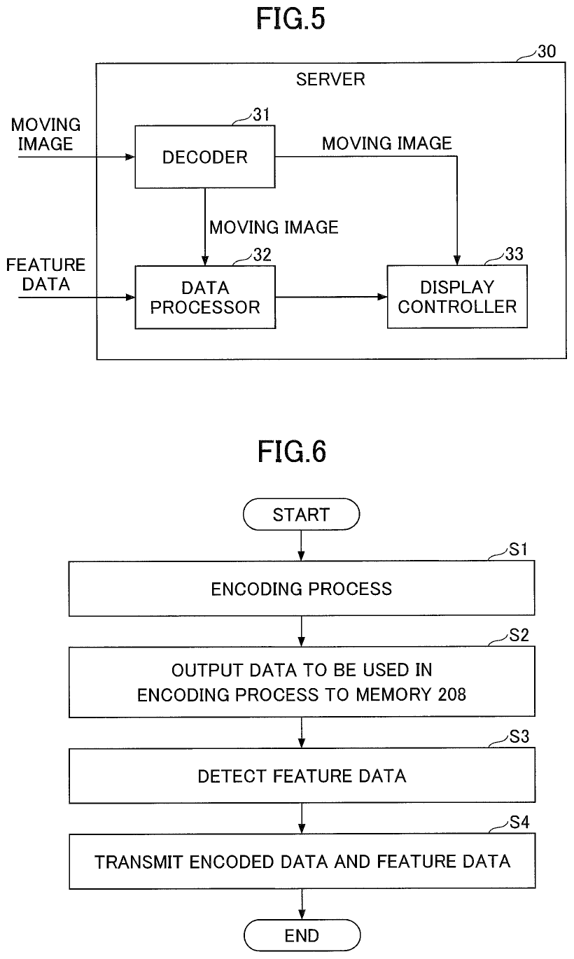

Next, with reference to FIG. 5, a functional configuration of the server 30 will be described. FIG. 5 is a diagram illustrating an example of a functional block diagram of a server 30 according to the embodiment. The server 30 includes a decoder 31, a data processor 32, and a display controller 33.

The decoder 31, the data processor 32, and the display controller 33 are implemented by processes which one or more programs installed in the server 30 cause the CPU 104 of the server 30 to execute.

The decoder 31 decodes a moving image and sound received from the moving image processor 20.

The data processor 32 uses feature data received from the moving image processor 20 and the moving image decoded by the decoder 31, to perform predetermined data processing. The data processor 32 performs as the predetermined data processing, for example, image processing, sound processing, inference processing, and the like which may pose higher loads.

The display controller 33 displays the feature data or the results of data processing, superimposed or added with the decoded moving image.

<Process>

(Process of Detecting Feature Data)

Next, with reference to FIG. 6, a process of detecting feature data on the moving image processor 20 will be described. FIG. 6 is a flow chart illustrating an example of a process of detecting feature data performed by the moving image processor 20. Note that the following process is performed for each frame in a moving image.

First, at Step S1, the encoder 22 performs a process of compressing and encoding a moving image.

Next, at Step S2, the encoder 22 outputs data used in the encoding process to the memory 208. Here, from the encoder circuit 207 illustrated in FIG. 2, the data used for the encoding process is stored in the memory 208. This enables the CPU 204 to refer to the data stored in the memory 208 used in the encoding process.

Note that the encoding process at Step S1 by the encoder 22 and the detection process by the detector 24 are performed in parallel. The encoding process performed by the encoder circuit 207 is a process performed by dedicated hardware; therefore, for example, in the case where a moving image is received in real time through streaming from the terminal 10, processing for each frame can be completed in approximately one tenth of the time required for real-time reception.

Next, at Step S3, the detector 24 uses the data stored in the memory 208, to detect, from the moving image, feature data representing features of the moving image received from the terminal 10. In this way, using the data used in the encoding process enables to significantly reduce the load of the process of detecting feature data.

Also, the process at Step S2 is performed during the course of the encoding process. If the processing load of the detection process performed by the detector 24 can be controlled such that detection can be completed within the time required for real-time reception of a moving image, it is possible to detect feature data in real time without wasting the processing performance of the encoder circuit 207.

Next, at Step S4, the outputter 25 transmits data in which the moving image has been encoded by the encoder 22, and the feature data detected by the detector 24, to the server 30.

The outputter 25 includes information in the feature data, where the information includes prerequisites such as date and time; information on processing conditions, algorithms, and the like when extracting the feature data; the total number of scenes; and the like. Information extracted for each scene, for each unit of GOP (Group of Pictures), and for each frame is also included.

Here, the scene includes a key frame and multiple successive frames (GOP), which serves as a unit for starting an analysis process of the moving image on the moving image processor 20 and on the server 30. The information on each scene includes information on the number of GOPs, the number of key frames, and the starting positions of the key frames. The information of each GOP unit includes information representing a data configuration such as the number of frames, information extracted in the encoding process performed by the encoder 22, and information detected by the detector 24. The information on each frame includes information from the frame extracted by the encoder 22 and information from the frame detected by the detector 24. The total number of scenes includes information detected by the detector 24 based on all scenes.

The outputter 25 may transmit feature data in a communication protocol different from the streaming of the encoded moving image, or may transmit the feature data in the same communication protocol.

Also, only the feature data may be transmitted. This enables to reduce the amount of data to be transmitted.

<Modified Example in the Case of Using Moving Images Captured with Multiple Cameras>

The detector 24 may use the data stored in the memory 208, to detect feature data representing features of moving images received from the multiple terminals 10 from the moving images. In this case, the moving images from the multiple terminals 10 may be integrated to detect the feature data. For example, in the case where the time is not synchronized among the terminals 10, based on overlapped parts of moving images within imaging ranges set in advance for the respective terminals 10, the detector 24 may synchronize the time of the moving images among the terminals 10, and then, cause the outputter 25 to transmit each of the moving images.

<Example of Detection Process of Feature Data>

In the following, an example of a process of detecting feature data will be described. Note that each of the following examples may be performed in combination as appropriate.

<<Example 1 of Detection Process of Feature Data>>

As Example 1 of the detection process of feature data, an example will be described in which a CTU (Coding Tree Unit) obtained during an encoding process in HEVC or the like (an example of a “block as a unit to which encoding is applied by the encoder 22”) is used for detecting a structure other than a background, or feature data related to the background at relatively high speed.

The encoder 22 uses HEVC or the like to perform an encoding process of each frame (picture) in a moving image with units of square pixel blocks called CTUs. In HEVC or the like, the size of each block in a frame is determined by the presence of an outline in the frame image and the complexity of the outline.

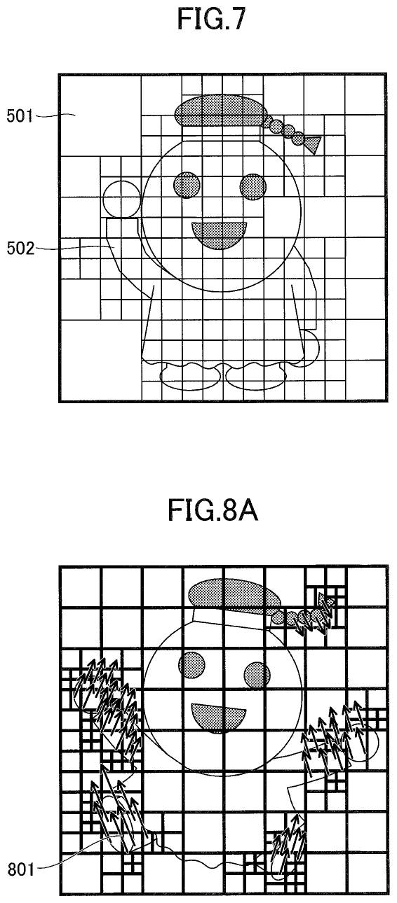

FIG. 7 is a diagram illustrating an example of the CTU. As illustrated in FIG. 7, a flat background part is partitioned into relatively large blocks (CBs: Coding Blocks) 501. Also, the outline of an object is partitioned into relatively small blocks 502.

Upon completion of the block partitioning process to determine the CTUs, the encoder 22 stores data of the CTUs in the memory 208. The data of the CTUs stored in the memory 208 includes data such as the layered structure and CB size of each CTB (Coding Tree Block), which is a block including color component signals, and adjacent CTBs.

The detector 24 may set the CTU data stored in the memory 208 as the feature data. This enables, for example, by using the feature data being the CTU data, to distinguish a background such as sky or a wall from a person or an object having a structure such as a building, and to extract data items that have similar compositions from among accumulated data items.

Also, the detector 24 may use the CTU data, for example, to detect an area of a detection target in an image, so as to set data of the detected area as the feature data. In this case, for example, in the case where the detection target is a person or the like, the detector 24 may prioritize searching in an area where the size of the CB is less than or equal to a predetermined value, to perform a process of detecting a face. This enables, for example, in the case of analyzing a moving image in real time, to improve the accuracy of a process of detecting an object such as a person, and to make the process even faster. In this case, as an algorithm for detecting a person or the like, a publicly-known algorithm may be used. Also, by using the CTU data, only areas whose CB size is less than or equal to a predetermined value (e.g., 16×16) may be set as the search range. This enables to detect an object further faster compared to a conventional method of searching in the entire image.

Also, for example, in the case where a background such as sky or a road is the detection target, the detector 24 may perform a process of detecting the background in areas where the size of a CB is greater than or equal to a predetermined value (e.g., 32×32) as the search range.

<<Example 2 of Detection Process of Feature Data>>

As Example 2 of the detection process of feature data, an example will be described in which a reduced image obtained during an encoding process is used for detecting feature data related to motion of an object at a relatively high speed.

In HEVC, AVC, or the like, a reduced image (a predicted image) is generated for each frame for motion compensation. Once having generated a reduced image for motion compensation, the encoder 22 stores data of the generated reduced image in the memory 208.

The detector 24 may set the data of the reduced image stored in the memory 208 as the feature data. This enables the server 30 to use the feature data for, for example, motion search or the like.

Also, the detector 24 may use the data of the reduced image, for example, to detect motion of a detection target in the image, to set data of the detected motion as the feature data. In this case, the detector 24 may find, for example, multiple candidates of search start areas, and select a search start area having a higher similarity from among the multiple candidates, to set the selected start area as the feature data. On the server 30, the search start area and its surroundings included in the feature data can be searched in detail using the same scale image.

<<Example 3 of Detection Process of Feature Data>>

As Example 3 of the detection process of feature data, an example will be described in which data representing changes between consecutive multiple frames during the course of an encoding process is used for detecting feature data related to motion of an object at a relatively high speed.

In HEVC, AVC, or the like, data representing changes between consecutive multiple frames is generated for motion compensation or the like. The data representing changes between consecutive multiple frames includes, for example, differences and motion vectors.

The difference may be the sum of absolute differences (SAD), sum of squared differences (SSD), sum of absolute transformed differences (SATD), or the like between the brightness and color difference of each pixel in a predetermined range included in a current frame, and the brightness and color difference of the corresponding pixel in the predetermined range included in the previous frame. The motion vector is data representing a predicted moving direction of a block to be encoded across consecutive frames.

Also, in HEVC, AVC, or the like, motion compensation prediction is performed for each prediction block (or PU: Prediction Unit).

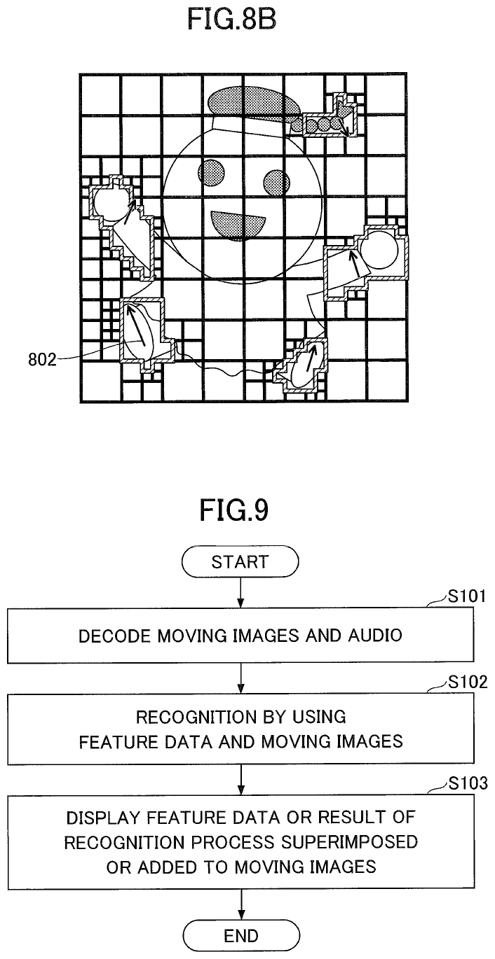

FIGS. 8A and 8B are diagrams illustrating motion information in HEVC. Prediction blocks adjacent to each other are considered to have similar motions; therefore, in HEVC, rather than encoding separate motion vectors for the respective prediction blocks, motion vectors for prediction blocks adjacent to each other are integrated to be encoded.

In an example in FIG. 8A, a motion vector for each prediction block is indicated by an arrow 801 and the like. In an example in FIG. 8B, a motion vector integrated among adjacent prediction blocks is indicated by an arrow 802 and the like.

Once having generated such data items for motion compensation, the encoder 22 stores the generated data items in the memory 208.

The detector 24 may set the data items stored in the memory 208 as the feature data. This enables the server 30 to use the feature data for, for example, motion search or the like.

Also, the detector 24 may use these data items, for example, to detect a motion or the like of a detection target in the image, so as to set data of the detected motion as the feature data. In this case, in the case where motions of a set of prediction blocks having sizes less than or equal to a predetermined value are integrated by the encoder 22, where the number of prediction blocks in the set is a predetermined number or greater, the detector 24 may prioritize searching in areas of the prediction blocks included in the set. This enables, for example, in the case of analyzing a moving image in real time, to improve the accuracy of a process of detecting an object such as a person, and to make the process even faster.

<<Example 4 of Detection Process of Feature Data>>

As Example 4 of the detection process of feature data, an example will be described in which data representing the complexity of frames obtained during the course of an encoding process is used for detecting feature data related to the complexity at relatively high speed.

In intra-prediction in HEVC, AVC, or the like, data items are calculated for SAD (sum of absolute differences), SATD (sum of absolute transformed differences), and the like of the brightness and the color differences in each single frame.

Once having generated these data items in intra-prediction, the encoder 22 stores the generated data items in the memory 208. The detector 24 may set the data items stored in the memory 208 as the feature data.

According to the detection process of feature data described above, for example, in a monitor camera system that monitors a moving image and sound from a monitor camera, it is possible to recognize the position and size of a face in an image and a person who has been imaged, and to detect feature data related to estimated information on the age and gender of the person, the colors of clothes, the possessions such as eyeglasses, a hat, a bag, and the like of the person.

Also, in the case where the installed position and orientation of the camera, and the angle of view, distortion, characteristics, and the like of the lens are known, or in the case where the camera has been calibrated in advance using a predetermined marker or the like, it is possible to detect feature data related to the size of an imaged person and the distance from the camera.

Also, by tracking the motion of a recognized person or object, it is possible to detect feature data related to behavior or action that represents what motions have been made. In this case, the feature data may include information on, for example, the orientations of the face, body, foot, and the like, motions of hands and feet, the position of each joint, facial expression, and the like, and information on behavior or action estimated in consideration of these. Note that the information may be detected every few frames or seconds.

Also, by using moving images captured by multiple cameras, behavior may be detected over a relatively wide range, so as to set the range of detected behavior set as the feature data. This enables to display a trajectory through which a person or an object has moved on a terminal of the user.

(Display Process Based on Feature Data)

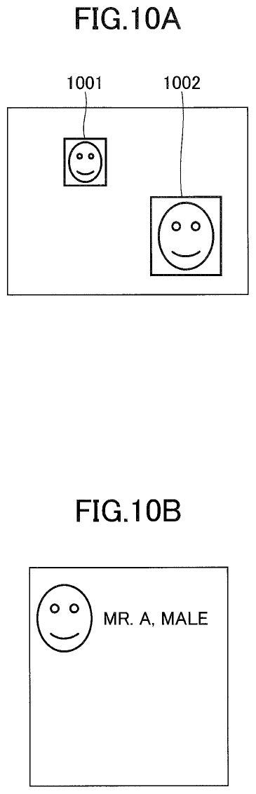

Next, with reference to FIGS. 9, 10A, and 10B, a display process on the server 30 based on feature data will be described. FIG. 9 is a flow chart illustrating an example of a display process based on feature data on the server 30. FIGS. 10A and 10B are diagrams illustrating examples of the display process based on feature data on the server 30.

At Step S101, the decoder 31 decodes a moving image and sound received from the moving image processor 20.

Next, at Step S102, the data processor 32 uses feature data received from the moving image processor 20 and the moving image decoded by the decoder 31, to perform predetermined data processing. Note that the processing at Step S101 and the processing at Step S102 may be performed simultaneously by parallel processing.

Next, at Step S103, the display controller 33 displays the feature data or results of the data processing, superimposed or added with the decoded moving image. In the example in FIG. 10A, areas of faces of two persons included in the feature data received from the moving image processor 20 are displayed superimposed with a moving image by frames 1001 and 1002. Here, for example, a screen illustrated in FIG. 10B is displayed by a press operation or the like within the frame 1002. In the example in FIG. 10B, an image within the frame 1002 is displayed, to which information on the name, gender, and the like of the person within the frame 1002 are added. Note that as for the name, gender, and the like of the person in the frame 1002, the image in the frame 1002 may be collated with facial images registered in advance on the moving image processor 20 or the data processor 32, to display the name, gender, and the like of a person having a highest degree of similarity greater than or equal to a predetermined value.

### Second Embodiment

In the first embodiment, examples have been described in which the moving image processing program uses data generated for encoding performed by the encoder circuit 207 as dedicated hardware, to cause the CPU 204 to detect feature data. In the second embodiment, an example will be described in which depending on the data size of a moving image received from the terminal 10 or the type of feature data of the detection target, switching is performed between encoding performed by the encoder circuit 207 as dedicated hardware, and encoding performed according to the moving image processing program processed by the CPU 204.

For example, assume that the encoder circuit 207 is a circuit that specializes in high-resolution moving images with relatively high resolutions, and for a low-resolution moving image, processing according to a program processed by the CPU 204 is faster than processing performed by the encoder circuit 207. Alternatively, for example, assume that the type of feature data of a detection target necessitates using data that is not generated in an implementation form of the encoder circuit 207, but the data can be generated if encoding is performed according to a program processed by the CPU 204. Even in these cases, according to the second embodiment, data generated for encoding is used for a process of detecting data related to a predetermined detection target from a moving image; therefore, it is possible to perform the process at relatively high speed.

Note that as the second embodiment is substantially the same as the first embodiment except for some parts, the description will be omitted appropriately. In the following, the parts common to the first embodiment will not be described, and only the different parts will be described. Note that the contents described in the second embodiment can also be applied to the first embodiment.

<Process>

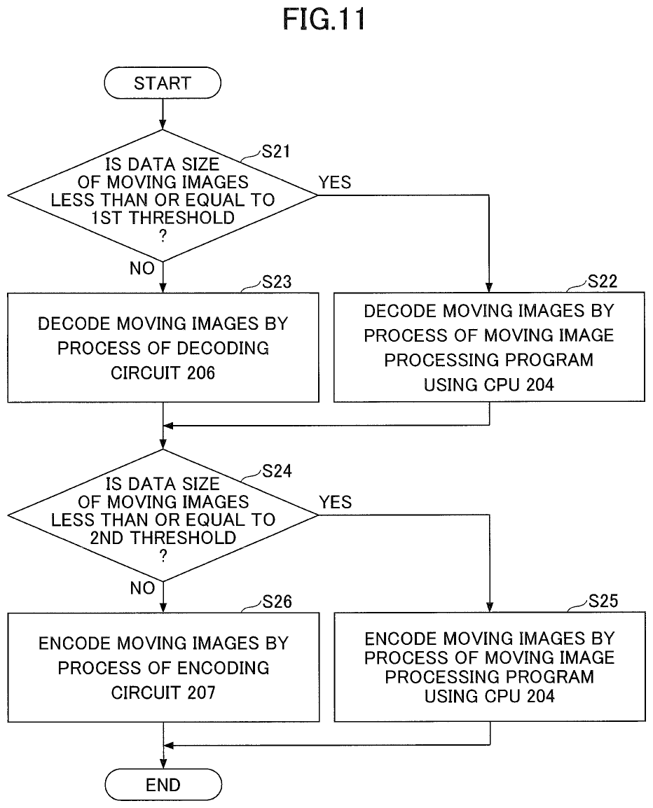

Next, with reference to FIG. 11, a process executed by a moving image processor 20 according to the second embodiment will be described. FIG. 11 is a flow chart illustrating an example of processing performed by the moving image processor 20 according to the second embodiment.

At Step S21, the controller 26 determines whether or not the data size (the resolution of frames) of a moving image received from the terminal 10 is less than or equal to a first threshold.

If the data size is less than or equal to the first threshold (YES at Step S21), at Step S22, the decoder 21 decodes the moving image received from the terminal 10 through a process according to the moving image processing program processed by the CPU 204, and proceeds to processing at Step S24, which will be described later.

If the data size is not less than the first threshold (NO at Step S21), at Step S23, the decoder 21 decodes the moving image received from the terminal 10 through a process executed by the decoder circuit 206.

Next, at Step S24, the controller 26 determines whether or not the data size of the moving image received from the terminal 10 is less than or equal to a second threshold.

If the data size is less than or equal to the second threshold (YES at Step S24), at Step S25, the encoder 22 encodes the moving image that has been received from the terminal 10 and decoded by the decoder 21, through a process according to the moving image processing program processed by the CPU 204, and then, completes the process.

If the data size is not less than the second threshold (NO at Step S24), at Step S26, the encoder 22 encodes the moving image that has been received from the terminal 10 and decoded by the decoder 21, through a process executed by the encoder circuit 207, and then, completes the process.

### Modified Example

The example described above is an example in which the determination is performed based on the data size of a moving image received from the terminal 10 at Step S21 and at Step S24; however, at least at one of Steps S21 and S24, the determination may be performed depending on the type of feature data of the detection target.

<Other>

Conventionally, in the case of performing a detection process from a moving image using dedicated hardware, there has been a problem that the logic of detection or the like cannot be changed afterward. According to the embodiment described above, the moving image processor 20 as a transcoder performs a detection process from the moving image through software processing; therefore, the logic of detection or the like can be changed.

The embodiments described above can be applied to a monitor camera system that recognizes a person from an image, a digital marketing system that analyzes whether a customer has picked up a product or purchased the product at a store, an IP distribution system, an AR/VR system that displays information on a subject superimposed with a moving image, and the like.

As above, the embodiments in the present disclosure have been described in detail; note that the present disclosure is not limited to such specific embodiments, and various modifications and changes can be made within the scope of the subject matters of the present inventive concept described in the claims.

Each functional unit of the moving image processor 20 may be implemented by, for example, cloud computing constituted with one or more computers. Also, the moving image processor 20 and the server 30 may be configured as an integrated device. The moving image processor 20 and the terminal 10 may be configured as an integrated device. In these cases, the moving image processor 20 does not necessarily need to perform the decoding process of a moving image. At least part of the functional units of the terminal 10 or the server 30 may be included in the moving image processor 20.

Note that the server 30 is an example of an “information processing apparatus”.

1. A moving image processor comprising:
an encoder configured to encode a moving image;
an obtainer configured to obtain data used in a process of compressing the moving image to be encoded by the encoder;
a detector configured to detect feature data representing a feature of the moving image from the moving image based on the data obtained by the obtainer; and
an outputter configured to output the data encoded by the encoder and the feature data detected by the detector.

2. The moving image processor as claimed in claim 1, further comprising:
a decoder configured to decode the moving image encoded in a first scheme,
wherein the encoder encodes the moving image decoded by the decoder by a second scheme different from the first scheme.

3. The moving image processor as claimed in claim 1, wherein the obtainer obtains data of blocks as units of encoding performed by the encoder, or reduced images of frames included in the moving image.

4. The moving image processor as claimed in claim 1, wherein the data used in the process of compressing the moving image to be encoded by the encoder includes at least one of data of blocks as units of encoding performed by the encoder, reduced images of frames included in the moving image, and data representing changes between consecutive multiple frames in the moving image.

5. The moving image processor as claimed in claim 4, wherein the detector searches in at least one of an area where sizes of blocks are less than or equal to a predetermined value and an area that has changed between the consecutive multiple frames, to detect the feature data.

6. The moving image processor as claimed in claim 1, wherein the feature data includes at least one of an area of an object as a detection target and a motion of the object.

7. The moving image processor as claimed in claim 1, wherein the outputter associates a frame in the moving image encoded by the encoder with the feature data detected by the detector from an image corresponding to the frame in the moving image, to output the feature data.

8. The moving image processor as claimed in claim 1, wherein the encoder transfers the data used in the process of compressing the moving image to be encoded by the encoder, to a memory, and
wherein the detector detects the feature data representing a feature of the moving image from the moving image based on the data stored in the memory.

9. The moving image processor as claimed in claim 1, wherein the moving image processor performs switching between encoding of the moving image performed by a CPU (Central Processing Unit), and encoding of the moving image performed by a dedicated circuit, depending on a resolution of frames of the moving image to be encoded and a type of the feature data of a detection target.

10. A moving image processing system comprising:
a moving image processor; and
an information processing apparatus,
wherein the moving image processor includes
an encoder configured to encode a moving image,
an obtainer configured to obtain data used in a process of compressing the moving image to be encoded by the encoder,
a detector configured to detect feature data representing a feature of the moving image from the moving image based on the data obtained by the obtainer, and
an outputter configured to output the data encoded by the encoder and the feature data detected by the detector, and
wherein the information processing apparatus includes
a decoder configured to decode the moving image received from the moving image processor, and
a display controller configured to display information according to the feature data superimposed or added with the moving image.

11. A moving image processing method, the method comprising:
encoding a moving image;
obtaining data used in a process of compressing the moving image to be encoded by the encoding;
detecting feature data representing a feature of the moving image from the moving image based on the data obtained by the obtaining; and
outputting the data encoded by the encoder and the feature data detected by the detecting.
